(19) United States
(12) Patent Application Publication
(10) Pub. No.: US 2026/0245082 A1
(43) Pub. Date: Aug. 20, 2026

(54) BLOCKCHAIN-BASED COMMITMENT SCHEME

(71) Applicant: nChain Licensing AG, Zug (CH)

(72) Inventors: Paul GERMOUTY, London (GB); Enrique LARRAIA, London (GB); Wei ZHANG, London (GB)

(21) Appl. No.: 19/161,163

(22) PCT Filed: Feb. 7, 2024
(86) PCT No.: PCT/EP2024/053014

§ 371 Date: Aug. 29, 2025

(30) Foreign Application Priority Data
Mar. 3, 2023 (GB) 2303136.2

(51) Int. Cl. G06Q 20/38; G06Q 20/40

(52) U.S. Cl. CPC G06Q 20/389; G06Q 20/38215; G06Q 20/401

(57) ABSTRACT

A computer-implemented method of making a commitment to a message upon which an outcome is to be determined, wherein the method is performed by a first participant of a group of participants, wherein a coordinator is associated with a coordinator public key, and wherein the method comprises: generating a first encrypted message by encrypting a first message with the coordinator public key; generating a first commitment value based on the first encrypted message; making the first commitment value available to the group of participants and the coordinator; and upon determining that each other participant has made a respective commitment value available to the group of participants the coordinator, making the first encrypted message and first reveal data available to the group of participants and the coordinator, wherein the first reveal data enables the first encrypted message to be obtained from the first commitment value.

### CROSS REFERENCE TO RELATED APPLICATIONS

This application is the U.S. National Stage of International Application No. PCT/EP2024/053014 filed on Feb. 7, 2024, which claims the benefit of United Kingdom Patent Application No. 2303136.2, filed on Mar. 3, 2023, the contents of which are all incorporated herein by reference in their entireties.

### TECHNICAL FIELD

The present disclosure relates to methods of committing to a message, to determine an outcome based on multiple committed messages, and to verifying the outcome. The methods may be used to implement a vote or auction, and may make use of the blockchain.

### BACKGROUND

Online auctions have a steadily growing market size, creating billions of US dollars of sales value every year. The main challenge of an online auction scheme is to ensure fairness and auditability while at the same time preserving each bidder's privacy. At the same time, utility driven blockchain technology is picking up pace, offering transparency and data integrity to many applications.

There are different types of auction. One type is known as a first-price sealed-bid auction (FPSBA), where bidders submit their bids in digitally sealed envelopes and send them to the auctioneer. After the bidding phase is closed, the auctioneer opens the envelopes and determines the highest bid. In FPSBA, the bids are kept private, so bidders are encouraged to bid according to their own valuation of the asset. It assumes that the auctioneer will not reveal a bidder's bid to any other bidders. Conducting the auction over a public blockchain adds transparency and immutability. The main properties of a FPSBA are:
Bid privacy: bidders cannot infer any information about other bids before submitting their bids.
Forward privacy: bidders cannot infer any information about non-winning bids. This assumes a semi-honest auctioneer.
Publicly verifiability: the correctness of the result can be audited by everyone after the results are published by the auctioneer.

Other desirable properties include bid binding (bidders cannot change their mind after the biding phase is closed), and financial fairness (if any bidder or the auctioneer misbehave, honest bidders are rewarded financially).

### SUMMARY

According to one aspect disclosed herein, there is provided a computer-implemented method of making a commitment to a message upon which an outcome is to be determined, wherein the method is performed by a first participant of a group of participants, wherein a coordinator is associated with a coordinator public key, and wherein the method is performed by a first participant and comprises: generating a first encrypted message by encrypting a first message with the coordinator public key; generating a first commitment value based on the first encrypted message; making the first commitment value available to the group of participants and the coordinator; and upon determining that each other participant has made a respective commitment value available to the group of participants the coordinator, making the first encrypted message and first reveal data available to the group of participants and the coordinator, wherein the first reveal data enables the first encrypted message to be obtained from the first commitment value.

According to one aspect disclosed herein, there is provided a computer-implemented method of determining an outcome based on respective messages from each of a group of participants, wherein a coordinator is associated with a coordinator public key, and wherein the method is performed by the coordinator and comprises: obtaining a respective commitment value generated by each respective participant; obtaining a respective encrypted message generated by each respective participant, wherein the respective encrypted message is generated by encrypting a respective message with the coordinator public key; obtaining respective reveal data generated by each respective participant; for each respective participant, using the respective reveal data to verify that the respective commitment value corresponds to the respective encrypted message; for each respective participant, determining the respective message by decrypting the respective encrypted message; and determining an outcome based on each respective message.

According to one aspect disclosed herein, there is provided a computer-implemented method of verifying an outcome determined based on respective messages from each of a group of participants, wherein the method is performed by a verifier and comprises:
obtaining a respective commitment value generated by each respective participant;
obtaining a respective encrypted message generated by each respective participant, wherein the respective encrypted message is generated by encrypting a respective message with the coordinator public key; obtaining respective reveal data generated by each respective participant; obtaining an outcome generated by the coordinator;
for each respective participant, using the respective reveal data to verify that the respective commitment value corresponds to the respective encrypted message; verifying the outcome; and making a result of the verification available to the group of participants and/or the coordinator.

Described herein is a blockchain-based first price sealed-bid auction scheme. The scheme offers enhanced privacy and public verifiability. It may be implemented on any public blockchain, which is leveraged to provide transparency, data integrity, and hence auditability. The impossibility of double spending on a blockchain is used to prevent bid replay attacks. Moreover, the scheme achieves non-repudiation efficiently for both bidders and auctioneer.

Some embodiments use ElGamal encryption and Bulletproofs to construct an efficient instantiation of the scheme. Some embodiments use recursive ZKSNARKs to reduce the number of proofs from 2n−2 to 1, where n is the number of bidders. Bulletproofs are short, non-interactive zero-knowledge proofs that can convince a verifier that an encrypted value lies within a stated range without disclosing any information about the value.

Note that whilst embodiments may be used to implement an auction scheme, they may be applied more generally to any other use case in which it is desirable for a plurality of parties to commit to a message or value (not necessarily monetary) without other parties becoming aware of that value, at least until a certain point in time, e.g. once an outcome based on the committed messages has been revealed.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 schematically illustrates an example system for implementing a blockchain-based auction,

FIG. 4 schematically illustrates another example system for implementing a blockchain-based auction

FIG. 5 shows the algorithms of an ElGamal encryption scheme,

FIG. 6 shows the algorithms of a randomised SHA3 commitment scheme,

FIG. 7 shows the algorithms of a sealed encryption protocol,

FIG. 8 shows the algorithms of a SNARK to compare two bids x_{w}, xᵢ encrypted in ElGamal ciphertexts ct_{w}, ctᵢ, and

FIG. 9 shows the algorithms of an auction scheme with ElGamal encryption and Bulletproofs.

### DETAILED DESCRIPTION OF EMBODIMENTS

### 1. Sealed Encryption

Embodiments described herein may be used to implement an auction, a vote, or any other scheme which requires parties to commit to a message (e.g. a value) such that the message cannot be changed or disputed at a later time, and in which an outcome can be determined based on the committed messages. Moreover, the messages may only be revealed to selected parties to preserve privacy.

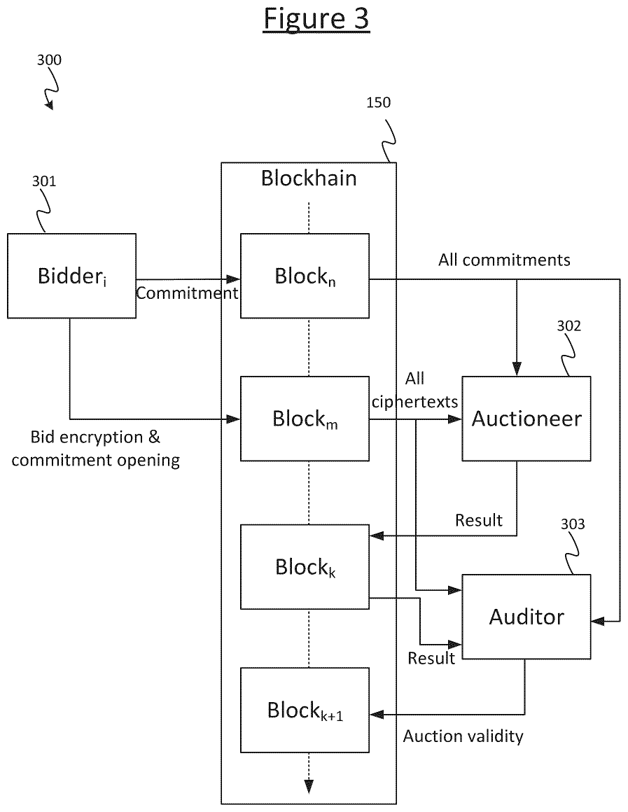

FIG. 3 illustrates an example system 300 for implementing some of the embodiments described herein. The system 300 comprises one or more participants (referred to herein as bidders) 301, a coordinating party (referring to herein as an auctioneer) 302 and a verifying party (referred to herein as an auditor) 303. Although only one bidder 301 is shown in FIG. 3, in general the system 300 may include any number of bidders 301. The system 300 may also include one or more blockchain nodes 104 of a blockchain network 106. Note that the use of a blockchain 150, whilst advantageous for reasons detailed below, is optional.

Each bidder 301 may be an individual user, a group of users, an organisation (e.g. a company), etc. Each bidder 301 operates respective computing equipment and may be configured to perform any of the actions described below as being performed by Alice 103a and/or Bob 103b. Similarly, the auctioneer 302 may be an individual user, a group of users, an organisation (e.g. a government body or bank), etc. The auctioneer 302 operates computing equipment and may be configured to perform any of the actions described below as being performed by Alice 103a and/or Bob 103b. Similarly, the auditor 303 may be an individual user, a group of users, an organisation (e.g. a regulatory body), etc. The auditor 303 may be a trusted third party. The auditor 303 operates computing equipment and may be configured to perform any of the actions described below as being performed by Alice 103a and/or Bob 103b.

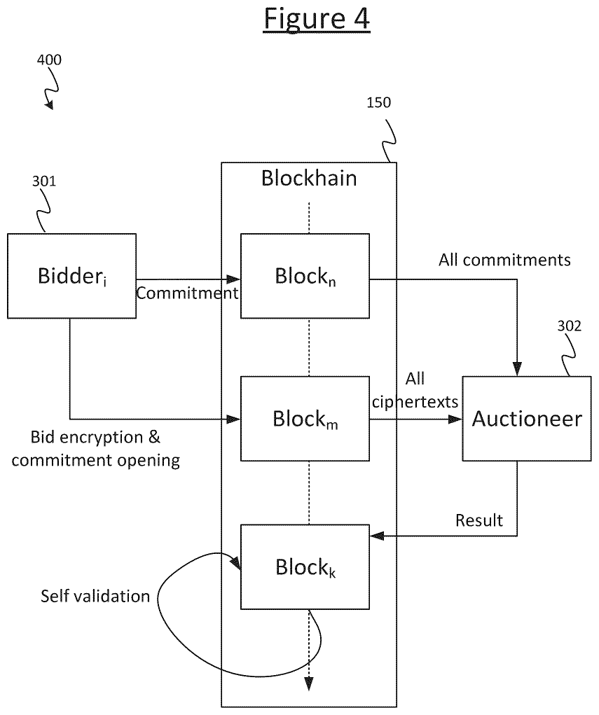

FIG. 4 also illustrates an example system 400 for implementing some of the embodiments described herein. The system 400 shown in FIG. 4 is similar to the system 300 shown in FIG. 3 except in this example the auditor 303 is not a separate entity. Instead, the actions of the auditor 303 are implemented by a self-executing smart contract stored on the blockchain 150.

Embodiments will primarily be described in terms of actions performed by a first bidder 301, but it will be appreciated that is purely for example purposes and each bidder 301 will be configured to perform equivalent actions.

The first bidder 301 determines a first message to commit to. The first message may be any type of data, and not necessarily a communication, though that is not excluded. In some examples, the first message comprises an offer (such as a bid) or a vote.

The first bidder 301 encrypts the first message, generating a first encrypted message. The encryption of the first message is based, at least in part, on a public key controlled by the auctioneer 302. In other words, the auctioneer has knowledge of the corresponding private key such that the auctioneer 302 can decrypt messages encrypted with the public key. Any suitable encryption method may be used, such as RSA encryption or ElGamal encryption.

The first bidder 301 generates a first commitment value based on the first encrypted message. Any suitable type of commitment may be used, such as a hash function (e.g. salted hash or randomised hash, e.g. randomised SHA3), a Pederson commitment, and so on. In some examples, each bidder 301 has a respective commitment key, and the commitment is based on a commitment key. More generally, a commitment value is a value that can be used to verify that the first bidder 301 has committed to the first encrypted message, which does not by itself reveal the first encrypted message itself. For example, a hash value is a commitment of a message because the message can be input to a hash function to produce the same hash value, whilst the hash value itself does not reveal any information about the message.

The first bidder 301 publishes the first commitment value so that it is accessible by the other bidders 301 and the auctioneer 302. Publishing the first commitment value may include submitting the first commitment value to the blockchain 150, or a different publicly accessible resource, such as a webpage stored on the internet. In some examples, publishing the first commitment may involve broadcasting the first commitment value to the other bidders 301 and the auctioneer 302.

The first bidder 301 determines that each other bidder 301 has published their own commitment value. This may be done by monitoring the public resource (e.g. the blockchain) for commitment values from the other bidders 301, or by receiving an indication from the auctioneer 302 that the other bidders 301 have submitted commitment values. In some examples, the first bidder 301 may receive the other commitment values directly from the other bidders 301.

After each other bidder 301 has published a respective commitment value, the first bidder publishes the first encrypted message and a first opening (also referred to a first reveal data). The opening/reveal data may be used to determine the first encrypted message from the first commitment. The skilled person will be familiar with the concept of openings and the like. The first encrypted message and the first opening may be published together or separately. The first encrypted message and the first opening may be published in any of the ways described above in relation to the first commitment value.

In the case that the blockchain 150 is used to publish the first commitment value, first encrypted message and first opening, the transaction containing the first encrypted message (and, optionally, the first opening) may reference the transaction containing the first commitment value. For example, the transaction containing the first encrypted message (and, optionally, the first opening) may include an input that spends an output of the transaction containing the first commitment value, and/or include a transaction identifier of the transaction containing the first commitment value.

In some examples, the commitment transaction (i.e. the transaction containing the first commitment value) may reference a UTXO controlled by the first bidder 301. In these examples, the first commitment value may additionally be based on a transaction identifier of the transaction containing the referenced UTXO.

Turning now to the actions performed by the auctioneer 302. The auctioneer 302 collects the commitment values provided by each bidder 301. This may include receiving the commitment values directly from the bidders 301, or retrieving the commitment values from the publicly accessible resource, such as the blockchain 150. The auctioneer 302 similarly gathers the encrypted messages and the openings, one pair from each bidder 301.

The auctioneer 302 uses the opening provided by a given bidder 301 to verify that the commitment value provided by that bidder 301 is a commitment to the encrypted message provided by that same bidder 301.

The auctioneer 302 uses its public key to decrypt the encrypted messages to determine the correspond plaintext messages. An outcome (i.e. a result) is then determined based on the decrypted messages. In some examples, if a commitment value does not correspond to an encrypted message, the corresponding decrypted message is not used to determine the result.

The form of the outcome will depend on the use case. In some examples, the outcome may be one of the respective messages. For instance, in the messages are bids (or values in general), the outcome may be the highest or lowest bid (or value). The outcome may be associated with one of the messages. That is, the outcome may not explicitly include one of the messages, but rather be linked to one of the messages. In some examples, the outcome comprises or is linked to multiple messages. In the case of a vote, the outcome may be a result of the vote, e.g. decision or winning candidate.

The auctioneer 302 may publish the outcome, e.g. to the blockchain 150. In some examples, the auctioneer 302 may broadcast the outcome to the bidders 301.

The auctioneer 302 may generate a proof (an “outcome proof” or a “result proof”) that proves the outcome corresponds to a particular message or messages. The proof may be a zero-knowledge proof. Example proofs are described below in section 2, any of which may be used to generate the outcome proof. The auctioneer 302 may publish the outcome proof, e.g. to the blockchain 150.

Similarly, the auctioneer 302 may generate one or more comparison proofs that prove that each of all but one of the messages is not the outcome, i.e. that one of the messages is the “best” or “winning” message, e.g. highest or lowest bid. That is, each comparison proof compares a given, non-winning message to the winning message. Each comparison proof may be a zero-knowledge proofs. As described in section 2 below, each proof may utilise Bullet proofs. The auctioneer 302 may publish the comparison proofs, e.g. to the blockchain 150.

In some examples, rather than publish multiple comparison proofs, the auctioneer 302 may generate a single comparison proof for all of the messages, and publish the single comparison proof, e.g. to the blockchain 150. The single proof may be a recursive SNARK, and may be generated as described below in section 2.

Depending on the use case, the auctioneer 302 may provide the bidder 301 who submitted the “winning” message with something in return, e.g. good or services, such as artwork. In some examples, this is contingent on the auditor 303 verifying the data submitted by the bidders 301 and/or the auctioneer 302.

The auditor 303 performs some of the same actions performed by the auctioneer 302, including obtaining the bidders' commitment values, encrypted messages and openings. The auditor 303 obtains the data in any suitable way, e.g. from the public resource (e.g. the blockchain 150), from the bidders 301, from the auctioneer 302, etc. The auditor 303 also obtains the outcome published by the auctioneer 302. The outcome may be obtained directly from the auctioneer, from a bidder 301, or from the public resource, e.g. the blockchain 150.

The auditor 303 is responsible for verifying the commitments published by the bidders and the outcome published by the auctioneer 302. The auditor 303 uses the openings to verify that each bidder's commitment value corresponds to that bidder's encrypted message. The auditor 303 also verifies that the outcome is correct. The auditor 303 then publishes a result of the verification (e.g. confirming that the outcome is correct). The verification result may be sent to the bidders 301 and/or the auctioneer 302 directly, published on the blockchain 150 or an alternative public resource, etc.

In some examples, the auditor 303 obtains one or more proofs for verifying the outcome generated by auctioneer 302. The proofs, generated by the auctioneer 302, have been described above. Further detail on examples proofs is provided in section 2 below.

It is noted again that embodiments have been described in terms of an auction purely by way of example, and that the terms bidder, auctioneer and auditor may be replaced throughout with participant, coordinator and verifier without.

### 2. Verifiable Sealed-Bid Auction on a Blockchain Revisited

### 2.1 Preliminaries

In this section we first describe the security model for FPSBA and then describe the building blocks used to construct our scheme.

### 2.1.1 Auction Model

Our protocol is a sealed bid auction in the semi honest auctioneer model, it satisfies the following properties:
Bid privacy: no bidders should be able to infer any information about other bids Forward bid privacy: in a semi-honest model, the privacy of the bid should remain even when the result are published, and a bidder should not give up privacy to prove his honest behaviour.
Bid binding: once the bid is committed to the blockchain, a bidder should not be able to change its mind and bid a different amount.
Public verifiable correctness: by looking at the blockchain anyone should be convinced that the winner is the one claimed by the auctioneer.
Financial fairness: a dishonest bidder or auctioneer should be financially penalized.
Non-interactivity: the only communication between the auctioneer and bidders is when publishing bids and result of the auction. No other interactions are necessary, especially bidders are not involved in the computation of results nor the public verification of the scheme.

We say that the auction is semi honest when the auction results are not impacted if the auctioneer colludes with a bidder. In our model we have privacy of the bid even if the bidder needs to prove its honesty. This property is trivial in our case as the bidder honesty is verifiable with public elements. We stress that this privacy consideration is new in a practical auction scheme.

Building blocks: to construct our auction protocol we use some cryptographic primitives such as Commitment, Encryption, Succinct Non-interaction Argument of Knowledge (SNARK). In the following section we formally describe these schemes.

### 2.1.2 Public Key Encryption

An encryption scheme E is described through four PPT algorithms

### (Setup,KeyGen,Encrypt,Decrypt):

Setup(1^{λ}), where λ is the security parameter, generates the global parameters param of the scheme;
KeyGen(param) outputs a pair of keys, a (public) encryption key pk and a (private) decryption key sk;
Encrypt(pk, M; ρ) outputs a ciphertext C, on a plaintext M, under the encryption key pk, using the randomness ρ;
Decrypt(sk, C) outputs M, encrypted in the ciphertext C or ⊥.

Our method to achieve verifiable auction is generic, however we give a concrete instantiation using randomized hash commitment, ElGamal encryption and Bulletproof zero knowledge argument.

### 2.1.3 Commitments

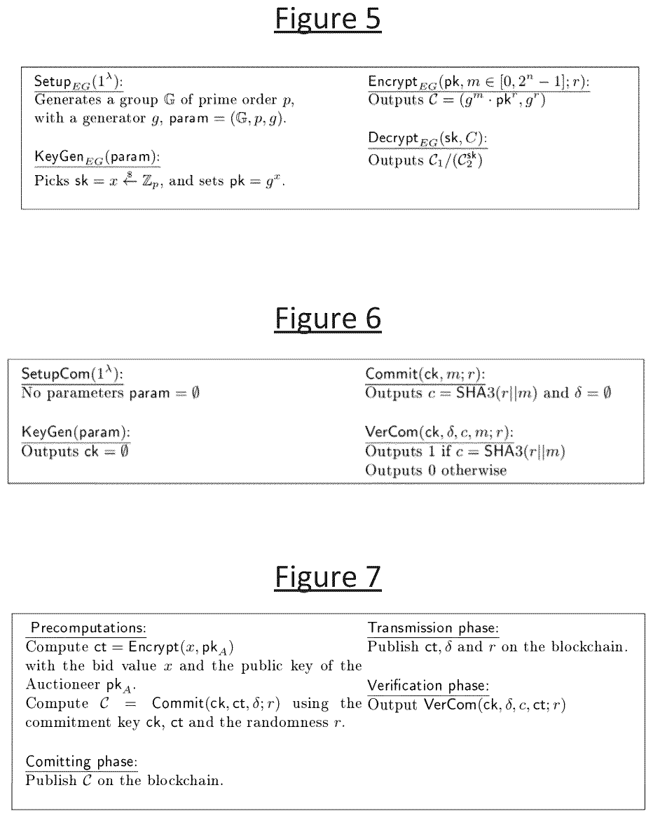

A commitment allows a user to commit to a value without revealing it, but without the possibility to later change his mind. It is composed of these algorithms (see also FIG. 5):
SetupCom(1^{λ}) generates the system parameters param, according to the security parameter λ.
KeyGen(param) generates a commitment key ck.
Commit(ck, m; r) produces a commitment c and an opening data δ on the input message m∈M using the random coins r←R.
VerCom(ck, δ, c, m; r) outputs 1 if c is a commitment of m with the randomness r for the commitment key ck along with opening data δ.

Such a commitment scheme should be both hiding, which says that the commit phase does not leak any information about m, and binding, which says that the decommit phase should not be able to open to two different messages. As a commitment scheme for our implementation we will use randomized SHA3 described in FIG. 6.

### 2.1.4 SNARKs and Bulletproofs

Given a fixed finite field [symbol] ₚ and an Fₚ-arithmetic circuit

$$C : {𝔽}_{p}^{n} \times {𝔽}_{p}^{h} \to \{ 0 , 1 \} ,$$

a pre-processing, zero-knowledge, succinct, non-interactive, argument system of knowledge (zkSNARK) for the NP relation

$${ℛ}_{C} := \{ ( x ; w ) ∈ {𝔽}_{p}^{n} \times {𝔽}_{p}^{h} \vert C ( x ; w ) = 1 \}$$

is a triplet of algorithms (Setup, Prove, Verify) such that:
   Setup(1^{λ}, [symbol] ) takes as input a security parameter λ and the description of a circuit C it outputs a pair of keys pk, vk.
   Prove(pk, x, w) takes the proving key pk, the public instance x and the private witness w and outputs a proof π.
   Verify(vk, x, π) takes the verification key vk, the public instance x, and the proof π and it either accepts or rejects.

The zkSNARK is complete if Verify always accepts proofs It generated by Prove on inputs (x; y)∈ [symbol] . It is succinct if |π|=O_{λ}(1), and it has a succinct verifier (sometimes also referred to as fully succinct) if Setup runs in time O_{λ}(|x|). It is zero-knowledge if no information about the witness w is leaked from the proof.

Knowledge soundness: regarding (knowledge) soundness, it must be possible to efficiently extract a witness from any (possibly cheating) prover Prove* that outputs an accepting pair (x, π). More formally, for every polynomial time adversary Prove* there exists a polynomial-time extractor Extract_{Prove*}, such that for every large-enough security parameter,

$$P [ \begin{matrix}\begin{matrix}Verify ( vk , x , π ) = 1 \\ ( x ; y ) ∉ {ℛ}_{C}\end{matrix} & \vert & \begin{matrix}( pk , vk ) ← Prove ( {1}^{λ} , C ) \\ ( x , π ) ← Prove * ( pk , vk ) \\ y ← {Extract}_{Prove *} ( pk , vk )\end{matrix}\end{matrix} ] \leq negl ( λ )$$

### 2.1.5 Bulletproofs

Bulletproof is a SNARK to prove interval membership x∈[0,2n). The public input is a Pedersen commitment C=Commit(ck, x; r):=g^{x}h^{r} of the integer x under commitment key ck:=(g, h)∈

$${𝔾}_{P}^{2} .$$

A prover convinces the verifier that a given x∈ [symbol] lies in range [0,2n) by showing it knows the bit decomposition b of x. Specifically, the NP relation is:

$${ℛ}_{B P} = \{ ( g , h , C ∈ {𝔾}_{P} , n ∈ N ) ; ( x , r ∈ {ℤ}_{P} ) \vert C = {g}^{x} {h}^{r} , x ∈ [ 0 , 2 n ) \}$$

The high-level idea is to prove in zero-knowledge that the following constraints are satisfied:

$$〈 b , 2 n 〉 = x ; and b ◦ {b}^{′} = 0 , and {b}^{′} = b - {1}^{n}$$

Above, 2ⁿ are all the powers of 2 up to 2ⁿ⁻¹, and · denotes component-wise product. The second and third constraints proves that elements in b are indeed bits, and the first constraint shows that b is the bit decomposition of x. To achieve logarithmic communication (in n), satisfiability of the above constraints is reduced to a inner product argument (sound but not zero-knowledge) In which the prover commits to messages m∈

$${ℤ}_{p}^{2 n}$$

of 2n elements using a (only-binding) length-reducing Pedersen vector commitment with key ck:=g∈

$${𝔾}_{p}^{2 n} ,$$

$$setting Commit ( ck , m ) := {\prod }_{i = 1}^{2 n} {g}_{i}^{{m}_{i}} .$$

The triplet of algorithms BP=(BP.Setup, BP.Prove, BP.Verify) is as follows:
BP.Setup(1^{λ},n) takes as input a security parameter λ and the description of the range [0,2n) it outputs a pair of keys

$${pk}_{b p} = v {k}_{b p} = g ∈ {𝔾}_{p ( λ )}^{2 n} .$$

BP.Prove(pk_{bp}, x, w) takes the proving key pk_{bp}, the public instance x:=(g, h, C) and the private witness w:=(x, r) and outputs a proof π_{bp}.
BP.Verify(vk_{bp}, x, π_{bp}) takes the verification key vk_{bp}, the public instance (g, h, C), and the proof π_{bp} and it either accepts or rejects.

Soundness. The soundness of Bulletproofs relies on the assumption that there is no known relationship between the group elements g, g, h. Recall g is the Vector Pedersen key used to commit to internal messages in the proving and verification algorithms of BP, and g, h is the Pedersen key (part of the public instance) used to commit to x in relation [symbol] _{BP}. The publicly-verifiable correctness of the result of our auction scheme will rely on the following theorem.

Theorem 1. If there is no known relationship between the group elements g, g, h, then BP with pk_{bp}=vk_{bp}=g is knowledge sound.

Bulletproofs are described in detail in Bünz, B., Bootle, J., Boneh, D., Poelstra, A., Wuille, P., Maxwell, G.: Bulletproofs: Short proofs for condential transactions and more. In: 2018 IEEE Symposium on Security and Privacy. pp. 315334. IEEE Computer Society Press, San Francisco, CA, USA (May 2123, 2018). doi.org/10.1109/SP.2018.00020.

### 2.2 Scheme Description

In this section we describe the details of our auction scheme. The interactions between the blockchain and the parties involved in the auction are framed in FIG. 3 and FIG. 4. The former describes the interactions in an environment without automated verification of the auction and the latter describes the interactions in an environment with automated verification of the auction.

In our auction protocol we distinguish four different phases: setup, bid, result, and public verification.

### 2.2.1 Setup Phase

In this phase, the auctioneer starts the auction with a public statement declaring the goods of the auction, the amount of time the auction will last and cryptographic parameters such as the group generator, the auctioneer public key and others.

### 2.2.2 Bidding Phase

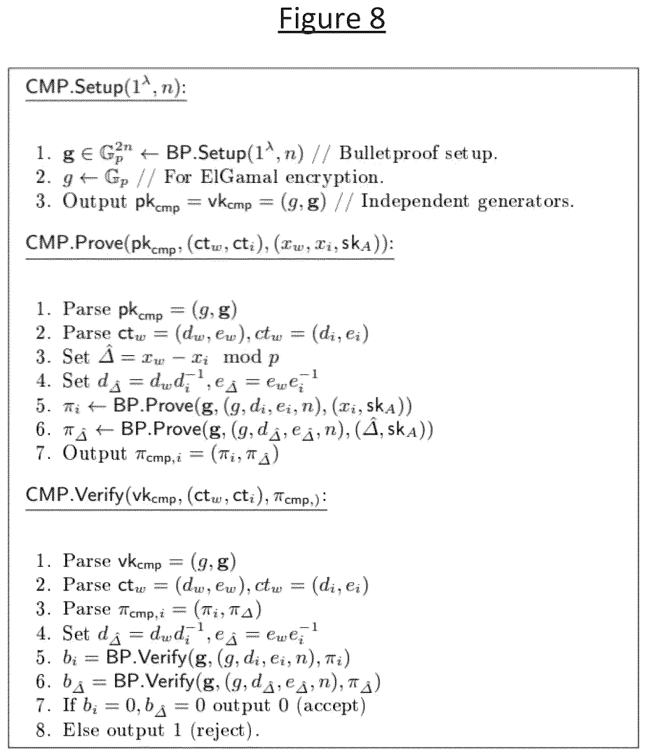

We constructed a new protocol to allow bidders to bid. This protocol is referred to herein as “Sealed Encryption” and described in FIG. 7 is of a sole interest and can be used in any protocol that requires to publicly commit a message but revealing this message to selected recipients. In our auction, the selected recipient is the auctioneer.

During the bidding phase the bidders will follow the steps committing and transmission of the sealed encryption protocol: in the former, the bidders will encrypt their bid and commit this ciphertext to the blockchain. In the latter, they will publish their ciphertext and the opening of the commitment.

2.2.3 Result phase

In this phase, the auctioneer decrypts all ciphertext and verifies they were correctly committed to the blockchain. The auctioneer identifies the winner bid x_{w} then produces a proof that x_{w} is correctly decrypted from ct_{w}, and also produces a comparison proof to prove that ′x_{w}>xᵢ′ for each non-winning bid xᵢ (a total of N−1 comparison proofs). Finally, the auctioneer publishes the proof and the winning bid on the blockchain. In the following, we explain how he can generate these proofs when ElGamal encryption is used.

Correct decryption proof. This is a proof of equal discrete logarithms. Let the auctioneer ElGamal public key pk_{A}=h=g^{skA}, and let the ElGamal ciphertext ct_{w}=(d_{w}, e_{w})=(g^{r}, g^{x}^{_{w}}h^{r}). If the ciphertext decrypts to x_{w} under secret key sk_{A}, then it holds

$${e}_{w} {x}_{w}^{- 1} = {h}^{r} = {d}_{w}^{s k A} .$$

Thus, the auctioneer proves in zero-knowledge that the group elements

$${e}_{w} {x}_{w}^{- 1}$$

and h have the same discrete logarithm sk_{A} in basis d_{w}, g respectively. There exists well-known Σ-protocols (three-move zero-knowledge proof systems) to prove equality of discrete logs on public basis.

Comparison proof. The auctioneer needs to prove that for each i≠w the bid x_{w} encrypted in the ElGamal ciphertext ct_{w}=(d_{w}, e_{w}) is greater than the bid xᵢ encrypted in ctᵢ=(dᵢ, eᵢ). We reduce bid comparison to checking interval membership, namely that x_{w}, xᵢ, Δᵢ=(x_{w}−xᵢ) mod p∈[0, B) for some fixed bound B:=2ⁿ≤p/2. The NP relation [symbol] _{CMP} for bid comparison is then as follows:

$${ℛ}_{CMP} = \{ \begin{matrix}\begin{matrix}g , {d}_{w} , {e}_{w} , {d}_{i} , {e}_{i} ∈ {𝔾}_{p} , n ∈ ℕ \\ {x}_{w} , {x}_{i} , {sk}_{A} ∈ {ℤ}_{p}\end{matrix} & \vert & \begin{matrix}{e}_{w} = {g}^{{x}_{w}} , {d}_{w}^{skA} \\ {e}_{i} = {g}^{{x}_{i}} , {d}_{i}^{skA} \\ {Δ}_{i} := ( {x}_{w} - {x}_{i} ) mod p \\ {x}_{i} , {Δ}_{i} ∈ [ 0 , {2}^{n} - 1 )\end{matrix}\end{matrix} \}$$

We use Bulletproofs as a building block. Recall from section 2.1.5 that Bulletproofs take as public input a Pedersen commitment C=g^{x}h^{r}∈ [symbol] ₚ, and as private input the integer x∈[0, 2ⁿ) and the opening r∈ [symbol] ₚ. Our observation is that an ElGamal ciphertext ct=(d, e)∈

$${𝔾}_{p}^{2} ,$$

encrypted with public key h=g^{sk} can be seen as a Pedersen commitment under commitment key ck=(g, d). More precisely, the second ciphertext component e can be seen as a Pedersen commitment with opening the secret key sk:

$$c t = ( d , e ) = ( {g}^{r} , {g}^{x} {h}^{r} ) = ( {g}^{r} , {g}^{x} {h}^{s k r} ) = ( d , {g}^{x} {h}^{s k} )$$

The above equation means that the auctioneer can use the ciphertext cti=(dᵢ, eᵢ) and his private key sk_{A} to prove with Bulletproofs that what the ciphertext decrypts to (the bid xᵢ) is in the valid range [0, 2ⁿ). Since ElGamal is additively homomorphic, the auctioneer can also derive a ciphertext for the difference Δᵢ setting

$$c {t}_{{Δ}_{i}} = ( {d}_{{Δ}_{i}} , {e}_{{Δ}_{i}} ) = ( {d}_{w} {d}_{i}^{- 1} , {e}_{W} {e}_{i}^{- 1} )$$

and prove Δᵢi∈[0, 2ⁿ). In FIG. 8 we detail the SNARK CMP=(CMP.Setup, CMP.Prove, CMP.Verify) to prove correct bid comparison. Thus, it proves that ((g, ct_{w}, ctᵢ, n); (x_{w}, xᵢ, sk_{A}))∈ [symbol] _{CMP}.

The correct auction result proof. This proof consists of the N−1 comparison proofs {π_{cmp}, i}_{i≠w} which comprises two Bulletproofs; and the correct decryption proof π_{dec} for the winning bid. The auctioneer uploads these proofs along with the winning bid x_{w} to the blockchain.

### 2.2.4 Public Verication

In any case an auditor, which can be implemented as an automated contract, will verify the correct behaviour of every party of the auction. This auditor will verify the correct computation of the proof and the correct computation of commitment and ciphertext. A wrong proof or a missing proof on a valid commitment and ciphertext would mean the auctioneer is dishonest. A wrong commitment would mean the bidder is dishonest. If no such things happen, the auction is valid and the winner wins the good and pays the amount x_{w}.

2.2.5 Implementation with ElGamal and Bulletproof

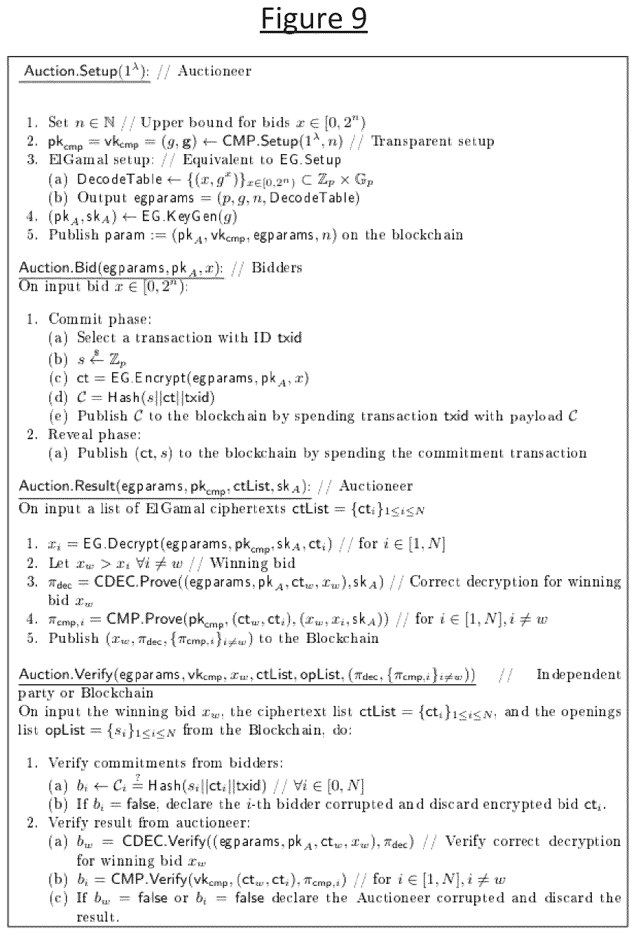

In our implementation, we choose the commitment to be a randomized hash which means that δ=s. To link the commitment to its bidder we need a mechanism to authenticate the bidder and we need to publish the commitment on the blockchain. In our scheme both of these aspects are handled by including the commitment in a transaction spending an unspent transaction outpoint (UTXO) owned by the bidder. Moreover, a reference to this UTXO will be included in the commitment to avoid replay attacks, as each UTXO can only be spent once on a public blockchain. In FIG. 9, we describe our implementation of our Auction.

### 2.3 Reducing the Number of Comparison Proofs

The approach described in Section 2.2 requires the auctioneer to generate N−1 comparison proofs, one per non-winning bidder. In this section we explain a generic approach that leverages recursive SNARKs to produce a single comparison proof attesting for the N−1 comparisons. Note that reducing the number of comparison proofs minimizes the uploaded data to the blockchain, and simplifies the process of verifying the correctness of the auction result.

Our technique allows to use any encryption scheme E for which it is possible to prove in zero-knowledge correct keypair generation and correct decryption (namely, without revealing the decryption key). The high-level idea is to define a comparison predicate [symbol] _{CMP} that evaluates to true only if the following is satisfied:
x_{w}>xᵢ, where x_{w} is the winning bid and xᵢ is any other bid.
ctᵢ correctly decrypts to xᵢ using decryption key sk_{A}.
sk_{A} is the decryption key corresponding to the auctioneer public key pk A

The above informal description corresponds to the predicate we want to enforce recursively. The recursive circuit [symbol] _{CMP} is augmented with logic implementing the verification algorithm of the recursive SNARK. It takes as additional inputs a proof π_{cmp,i-1}, attesting to the satisfiability of [symbol] _{CMP} on some other ciphertext ctᵢ₋₁ and bid xᵢ₋₁, and checks the proof π_{cmp,i-1} is valid.

So far we have explained how the comparison proofs can be recursed. We now show how to make sure the recursive comparison is done exactly on the bids encrypted in the ciphertexts {ctᵢ}_{i≠w} posted in the blockchain in the bid phase. We show two ways of enforcing this.

Sequential recursion. For simplicity, below we assume N−1=2^{d} We arrange the 2^{d} ciphertexts as the leaves of a Merkle tree, whose root is given as public input. An extra gadget is added to the comparison predicate [symbol] _{CMP}: it receives the root of the tree as public input, and the Merkle proof for the ith leaf as private input. It enforces ctᵢ is in the tree using the Merkle proof. This approach has the disadvantage that proof generation is sequential. Thus, the auctioneer cannot generate π_{cmp,i} at the same time than π_{cmp,i-1}.

Parallel recursion. Now we assume N−1=2^{d}−1. To be able to batch proof generation we see the ciphertexts as the 2^{d}−1 root nodes of a Merkle tree of depth d−1. We define the hash at node i as hᵢ=Hash(ctᵢ, h_{i,0}, h_{i,1}), where h_{i,b} denotes the hashes of the two children of node i. The extra gadget of [symbol] _{CMP} this time receives as public input the hash hᵢ, and as private inputs, the two child ciphertexts, the two child hashes, and the four grandchild hashes. It enforces correct hash generation. The downside with respect the previous approach is that the complexity is increased because now two child proofs must be verified in the recursive circuit [symbol] _{CMP} (instead of one proof verification as in the sequential recursion). However, note that to generate proofs at layer k of the tree, the recursive prover only needs two proofs from the previous layer k−1, and all the proofs in the same layer can be parallelised. Thus, we can parallelise proof generation in batches of 2^{d-1}, 2^{d-2}, . . . , 2 sizes.

### 3. Example System Overview

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

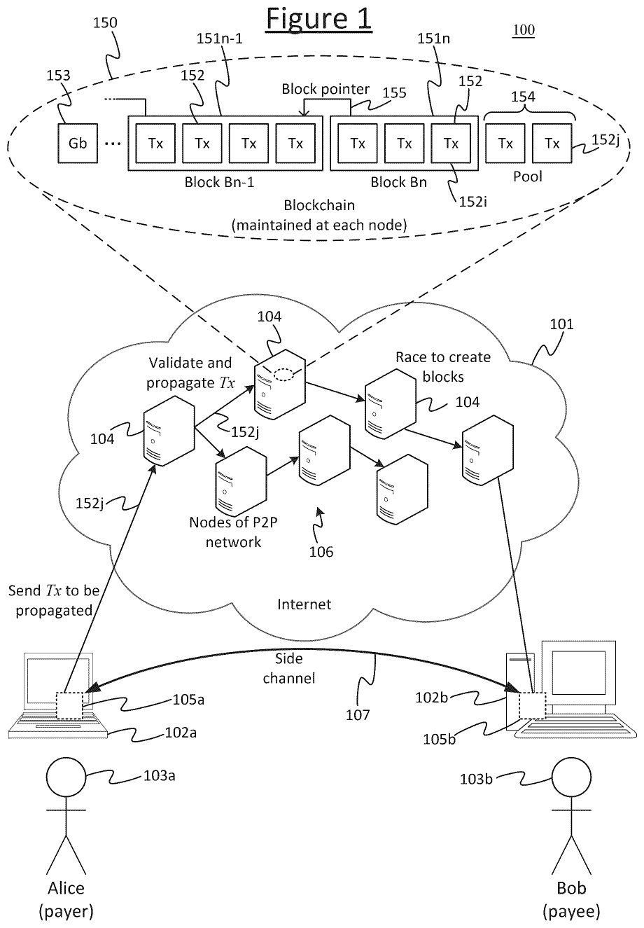

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”.

This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 4. UTXO-Based Model

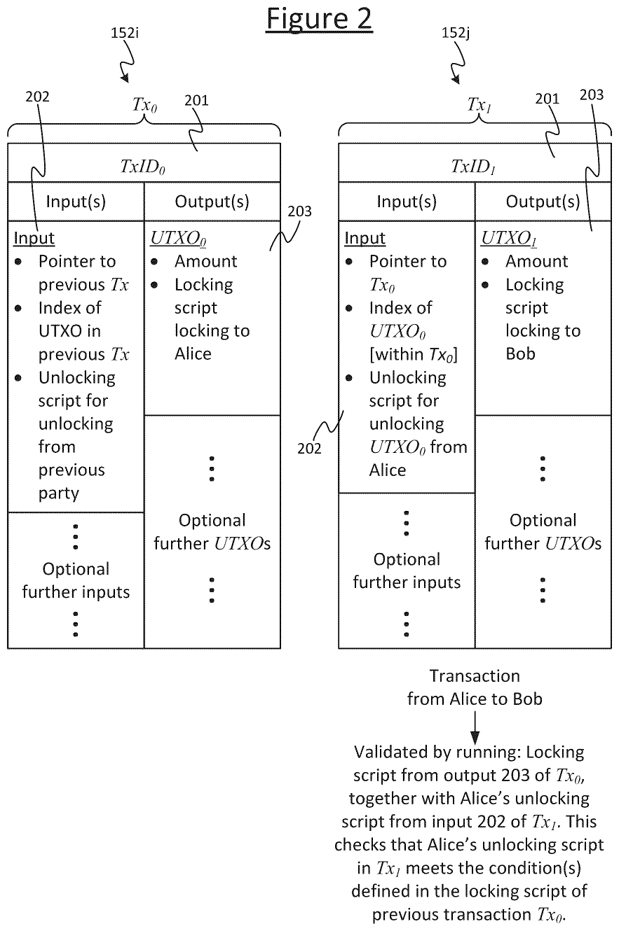

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 5. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method of making a commitment to a message upon which an outcome is to be determined, wherein the method is performed by a first participant of a group of participants, wherein a coordinator is associated with a coordinator public key, and wherein the method is performed by a first participant and comprises:
generating a first encrypted message by encrypting a first message with the coordinator public key;
generating a first commitment value based on the first encrypted message;
making the first commitment value available to the group of participants and the coordinator; and
upon determining that each other participant has made a respective commitment value available to the group of participants the coordinator, making the first encrypted message and first reveal data available to the group of participants and the coordinator, wherein the first reveal data enables the first encrypted message to be obtained from the first commitment value.

Statement 2. The method of statement 1, wherein said making of the first commitment value available to the group of participants and the coordinator comprises sending a first commitment transaction to one or more blockchain nodes for publishing on a blockchain, wherein the first commitment transaction comprises the first commitment value.

Statement 3. The method of statement 1 or statement 2, wherein said making of the first encrypted message and the first reveal data available to the group of participants and the coordinator comprises sending a first reveal transaction to one or more blockchain nodes for publishing on the blockchain, wherein the first reveal transaction comprises the first encrypted message and the first reveal data.

Statement 4. The method of statement 2 and statement 3, wherein the first reveal transaction comprises a reference to the first commitment transaction.

Statement 5. The method of any of statements 2 to 4, wherein the first commitment transaction comprises an input that references an output of a first transaction, wherein the output of the first transaction is controlled by a first public key associated with the first participant.

Statement 6. The method of statement 5, wherein the first commitment value is based on a transaction identifier of the first transaction.

Statement 7. The method of any preceding statement, wherein the first encrypted message is generated using ElGamal encryption.

Statement 8. The method of any preceding statement, wherein the first commitment value is one of: a hash commitment or a Pederson commitment generated based on the first encrypted message. The hash commitment may be a salted or randomised hash.

Statement 9. The method of any preceding statement, wherein the first message comprises a vote or a (financial) offer.

Statement 10. The method of any preceding statement, comprising:
making the first commitment value available to a verifier; and
making the first encrypted message and first reveal data available to the verifier.

Statement 11. A computer-implemented method of determining an outcome based on respective messages from each of a group of participants, wherein a coordinator is associated with a coordinator public key, and wherein the method is performed by the coordinator and comprises:
obtaining a respective commitment value generated by each respective participant;
obtaining a respective encrypted message generated by each respective participant, wherein the respective encrypted message is generated by encrypting a respective message with the coordinator public key;
obtaining respective reveal data generated by each respective participant;
for each respective participant, using the respective reveal data to verify that the respective commitment value corresponds to the respective encrypted message;
for each respective participant, determining the respective message by decrypting the respective encrypted message; and
determining an outcome based on each respective message.

Statement 12. The method of statement 11, wherein said determining of the outcome comprises using only the respective messages whose respective encrypted message corresponds to the respective commitment value to determine the outcome.

Statement 13. The method of statement 11 or statement 12, wherein the outcome comprises or is associated with one of the respective messages.

Statement 14. The method of any of statements 11 to 13, comprising making the outcome available to the group of participants.

Statement 15. The method of statement 14, wherein said making of the outcome available to the group of participants comprises sending an outcome transaction to one or more nodes of a blockchain network, wherein the outcome transaction comprises at least one of:
the outcome, an indication of the outcome, the respective participant associated with the outcome.

Statement 16. The method of any of statements 11 to 15, wherein:
said obtaining of the respective commitment value comprises obtaining the respective commitment value from the blockchain, and/or
said obtaining of the respective encrypted message comprises obtaining the respective encrypted message from the blockchain, and/or
said obtaining of the respective reveal data comprises obtaining the respective encrypted message from the blockchain.

Statement 17. The method of any of statements 11 to 16, comprising:
generating an outcome proof proving that the outcome is based on each respective message; and
   making the outcome proof available to the group of participants.

Statement 18. The method of statement 13 or any statement dependent thereon, comprising:
generating an outcome proof proving that the respective message is decrypted from the respective encrypted message; and
making the outcome proof available to the group of participants.

Statement 19. The method of statement 17 or statement 18, wherein said making of the outcome proof available to the group of participants comprises sending an outcome proof transaction to one or more nodes of the blockchain network, wherein the outcome proof transaction comprises the outcome proof.

Statement 20. The method of any of statements 17 to 19, wherein the outcome proof comprises a zero-knowledge proof.

Statement 21. The method of statement 13 or any statement dependent thereon, comprising:
for each respective message which the outcome does not comprise or is not associated with, generating a respective comparison proof proving that the outcome does not comprise or is not based on the respective message; and
making each respective comparison proof available to the group of participants.

Statement 22. The method of statement 21, wherein said making of each respective comparison proof available to the group of participants comprises sending a comparison proof transaction to one or more nodes of the blockchain network, wherein the comparison proof transaction comprises each respective comparison proof.

Statement 23. The method of statement 22, wherein each respective comparison proof comprises a respective zero-knowledge proof.

Statement 24. The method of statement 23, wherein each respective zero-knowledge proof comprises a respective Bullet proof.

Statement 25. The method of statement 13 or any statement dependent thereon, comprising:
based on each respective message, generating a single comparison proof proving how the outcome is associated with each respective message; and
making the single comparison proof available to the group of participants.

Statement 26. The method of statement 25, wherein said making of the single comparison proof available to the group of participants comprises sending a comparison proof transaction to one or more nodes of the blockchain network, wherein the comparison proof transaction comprises the single comparison proof.

Statement 27. The method of statement 26, wherein the single comparison proof comprises a recursive Succinct Non-interaction Argument of Knowledge (SNARK) proof.

Statement 28. A computer-implemented method of verifying an outcome determined based on respective messages from each of a group of participants, wherein the method is performed by a verifier and comprises:
obtaining a respective commitment value generated by each respective participant;
obtaining a respective encrypted message generated by each respective participant, wherein the respective encrypted message is generated by encrypting a respective message with the coordinator public key;
obtaining respective reveal data generated by each respective participant;
obtaining an outcome generated by the coordinator;
   for each respective participant, using the respective reveal data to verify that the respective commitment value corresponds to the respective encrypted message;
verifying the outcome; and
   making a result of the verification available to the group of participants and/or the coordinator.

Statement 29. The method of statement 28, wherein said verifying of the outcome comprises:
obtaining an outcome proof proving that the outcome is based on each of the respective messages and/or that the outcome comprises or is associated with one of the respective messages; and
using the outcome proof to verify the outcome.

Statement 30. The method of statement 28 or statement 29, wherein the outcome comprises or is associated with one of the respective messages, and wherein said verifying of the outcome comprises:
obtaining, for each respective message which the outcome does not comprise or is not associated with, a respective comparison proof proving that the outcome does not comprise or is not associated with the respective message; and
using the respective comparison proofs to verify the outcome.

Statement 31. The method of statement 28 or statement 29, wherein said verifying of the outcome comprises:
obtaining, a single comparison proof proving how the outcome is associated with each respective message; and
using the single comparison proof to verify the outcome.

Statement 32. The method of any of statements 28 to 31, wherein:
said obtaining of the respective commitment value comprises obtaining the respective commitment value from the blockchain, and/or
said obtaining of the respective encrypted message comprises obtaining the respective encrypted message from the blockchain, and/or
said obtaining of the respective reveal data comprises obtaining the respective encrypted message from the blockchain, and/or
said obtaining of the outcome comprises obtaining the outcome from the blockchain.

Statement 33. The method of any of statements 28 to 32, wherein said making of the result available to the group of participants and/or the coordinator comprises sending a result transaction to one or more nodes of the blockchain network, wherein the result transaction comprises the result.

Statement 34. The method of any of statements 28 to 33, wherein the verifier is implemented as a smart contract stored on the blockchain.

Statement 35. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 34.

Statement 36. A computer program embodied on computer-readable storage and configured so as, when run on one or more processors, to perform the method of any of statements 1 to 34.

According to another aspect disclosed herein, there may be provided a method comprising the actions of any or all of the first participant, the coordinator and the verifier. According to another aspect disclosed herein, there may be provided a system comprising the computer equipment of any or all of the first participant, the coordinator and the verifier.

1. A computer-implemented method of making a commitment to a message upon which an outcome is to be determined, wherein the method is performed by a first participant of a group of participants, wherein a coordinator is associated with a coordinator public key, and wherein the method is performed by a first participant and comprises:
generating a first encrypted message by encrypting a first message with the coordinator public key;
generating a first commitment value based on the first encrypted message;
making the first commitment value available to the group of participants and the coordinator; and
upon determining that each other participant has made a respective commitment value available to the group of participants the coordinator, making the first encrypted message and first reveal data available to the group of participants and the coordinator, wherein the first reveal data enables the first encrypted message to be obtained from the first commitment value.

2. The method of claim 1, wherein said making of the first commitment value available to the group of participants and the coordinator comprises sending a first commitment transaction to one or more blockchain nodes for publishing on a blockchain, wherein the first commitment transaction comprises the first commitment value.

3. The method of claim 1, wherein said making of the first encrypted message and the first reveal data available to the group of participants and the coordinator comprises sending a first reveal transaction to one or more blockchain nodes for publishing on a blockchain, wherein the first reveal transaction comprises the first encrypted message and the first reveal data.

4-6. (canceled)

7. The method of claim 1, wherein the first encrypted message is generated using EIGamal encryption.

8. The method of claim 1, wherein the first commitment value is one of: a hash commitment or a Pederson commitment generated based on the first encrypted message.

9. The method of claim 1, wherein the first message comprises a vote or an offer.

10. The method of claim 1, comprising:
making the first commitment value available to a verifier; and
making the first encrypted message and first reveal data available to the verifier.

11. A computer-implemented method of determining an outcome based on respective messages from each of a group of participants, wherein a coordinator is associated with a coordinator public key, and wherein the method is performed by the coordinator and comprises:
obtaining a respective commitment value generated by each respective participant;
obtaining a respective encrypted message generated by each respective participant, wherein the respective encrypted message is generated by encrypting a respective message with the coordinator public key;
obtaining respective reveal data generated by each respective participant;
for each respective participant, using the respective reveal data to verify that the respective commitment value corresponds to the respective encrypted message;
for each respective participant, determining the respective message by decrypting the respective encrypted message; and
determining an outcome based on each respective message.

12. The method of claim 11, wherein said determining of the outcome comprises using only the respective messages whose respective encrypted message corresponds to the respective commitment value to determine the outcome.

13. The method of claim 11, wherein the outcome comprises or is associated with one of the respective messages.

14. The method of claim 11, comprising making the outcome available to the group of participants.

15. (canceled)

16. The method of claim 11, wherein:
said obtaining of the respective commitment value comprises obtaining the respective commitment value from a blockchain, and/or
said obtaining of the respective encrypted message comprises obtaining the respective encrypted message from the blockchain, and/or
said obtaining of the respective reveal data comprises obtaining the respective encrypted message from the blockchain.

17. The method of claim 11, comprising:
generating an outcome proof proving that the outcome is based on each respective message; and
making the outcome proof available to the group of participants.

18. (canceled)

19. The method of claim 17, wherein said making of the outcome proof available to the group of participants comprises sending an outcome proof transaction to one or more nodes of a blockchain network, wherein the outcome proof transaction comprises the outcome proof.

20-27. (canceled)

28. A computer-implemented method of verifying an outcome determined based on respective messages from each of a group of participants, wherein the method is performed by a verifier and comprises:
obtaining a respective commitment value generated by each respective participant;
obtaining a respective encrypted message generated by each respective participant, wherein the respective encrypted message is generated by encrypting a respective message with a coordinator public key;
obtaining respective reveal data generated by each respective participant;
obtaining an outcome generated by the coordinator;
for each respective participant, using the respective reveal data to verify that the respective commitment value corresponds to the respective encrypted message;
verifying the outcome; and
making a result of the verification available to the group of participants and/or the coordinator.

29. The method of claim 28, wherein said verifying of the outcome comprises:
obtaining an outcome proof proving that the outcome is based on each of the respective messages and/or that the outcome comprises or is associated with one of the respective messages; and
using the outcome proof to verify the outcome.

30. The method of claim 28, wherein the outcome comprises or is associated with one of the respective messages, and wherein said verifying of the outcome comprises:
obtaining, for each respective message which the outcome does not comprise or is not associated with, a respective comparison proof proving that the outcome does not comprise or is not associated with the respective message; and
using the respective comparison proofs to verify the outcome.

31. The method of claim 28, wherein said verifying of the outcome comprises:
obtaining, a single comparison proof proving how the outcome is associated with each respective message; and
using the single comparison proof to verify the outcome.

32. The method of claim 28, wherein:
said obtaining of the respective commitment value comprises obtaining the respective commitment value from a blockchain, and/or
said obtaining of the respective encrypted message comprises obtaining the respective encrypted message from the blockchain, and/or
said obtaining of the respective reveal data comprises obtaining the respective encrypted message from the blockchain, and/or
said obtaining of the outcome comprises obtaining the outcome from the blockchain.

33. The method of claim 28, wherein said making of the result available to the group of participants and/or the coordinator comprises sending a result transaction to one or more nodes of a blockchain network, wherein the result transaction comprises the result.

34-36. (canceled)
